(19) United States
(12) Patent Application Publication
(10) Pub. No.: US 2011/0300468 A1
(43) Pub. Date: Dec. 8, 2011

(54) FUEL CELL DEVICE

(75) Inventors: Hiroshi Takabayashi, Kanagawa (JP); Akihisa Inatani, Kanagawa (JP); Yoshiaki Kumagai, Kanagawa (JP); Arinobu Ueda, Tokyo (JP)

(73) Assignee: SONY CORPORATION, Tokyo (JP)

(21) Appl. No.: 13/202,051

(22) PCT Filed: Feb. 4, 2010
(86) PCT No.: PCT/JP2010/052003

§ 371 Date: Aug. 17, 2011

(30) Foreign Application Priority Data
Feb. 23, 2009 (JP) 2009-038800

(51) Int. Cl. H01M 8/04; H01M 8/10; H04R 1/02; H01M 16/00

(52) U.S. Cl. 429/482; 429/515; 381/332

(57) ABSTRACT

A housing contains a fuel cell, a lithium ion secondary cell, a wiring board on which a control circuit and the like are mounted, a light-emitting diode and the like. The bottom surface of the housing is covered with a bottom plate. A plurality of air-intake holes are formed in the bottom plate to supply air to the fuel cell. Two USB ports and are provided in the periphery of the housing. A plurality of air-discharge holes are formed in the upper portion of the periphery of the housing. Gas in the housing is discharged to the outside through the air-discharge holes. Furthermore, light from an LED provided in the housing works as an illumination for the fuel cartridge, which can facilitate checking of the fluid level of the fuel cartridge, thus, checking of the amount of remaining fuel.

### TECHNICAL FIELD

The present invention relates to a fuel cell device applicable to electronic devices, including a charger, using a fuel cell, for example, a direct methanol fuel cell.

### BACKGROUND ART

Fuel cells can be classified into various types depending on the type of electrolyte and the like. One known typical fuel cell is a polymer electrolyte fuel cell (PEFC) using a solid polymer electrolyte as electrolyte. The polymer electrolyte fuel cell is suitable for a power supply for driving an electronic device because it can be produced at a lower cost, can be easily smaller, thinner and lighter, and can provide high output density in terms of cell performance. For the polymer electrolyte fuel cell, in addition to a type using hydrogen as fuel, another type has been developed which modifies methanol or natural gas to generate hydrogen to be used as fuel. In recent years, a direct methanol fuel cell (DMFC) has been developed in which methanol as fuel is directly supplied to a fuel cell to generate electricity.

In the direct methanol fuel cell, a membrane and electrode assembly (MEA) into which an electrolyte membrane and a pair of electrodes are integrated and a flat plate-shaped separator having a fuel channel in one surface and an oxidant gas channel in the other surface are alternately stacked on a base plate. Supplying methanol-water solution to the fuel channel and air to the oxidant gas channel causes a power generation reaction on the electrolyte membrane. In the direct methanol fuel cell, water and carbon dioxide are produced as a product and discharged.

An active (forced intake-type) fuel cell in which fuel is supplied to a fuel cell and product of power generation (water, carbon dioxide) is discharged using an auxiliary, such as a pump, has been proposed, and a passive (open-type) fuel cell in which methanol-water solution, air and the like spread naturally and no auxiliary is used has been proposed. Previously, a fuel cell used as a charging cradle for mobile phone has been described in Japanese Patent No. 4005608.

As for a charger, with the widespread use of mobile devices, including mobile phones, notebook computers, portable audio/video devices and mobile terminals, a charger capable of charging secondary cells of a plurality of mobile devices is required. For example, a USB charger having a universal serial bus (USB) terminal may satisfy such a requirement.

### DISCLOSURE OF THE INVENTION

### Problems to be Solved by the Invention

As a fuel cell, a thin fuel cell unit has been proposed having a structure in which a plurality of unit cells (fuel cells) are arranged in a plane on a thermoplastic resin sheet and connected in series. For a thin fuel cell, for example, a direct methanol fuel cell, methanol-water solution as fuel is supplied from a fuel cartridge to a fuel electrode (hereinafter referred to as anode electrode). Oxygen (air) is supplied from an opening of an outer housing to an air electrode (hereinafter referred to as cathode electrode). A problem exists that the amount of fuel remaining in the fuel cartridge is not immediately obvious.

In view of the above, it is an object of the present invention to provide a fuel cell device that can obviously indicate the amount of fuel remaining in the fuel cartridge.

### Means for Solving the Problems

In order to solve the above-described problem, the invention is a fuel cell device including:

a housing forming a fuel cell containing space for containing a fuel cell;

a fuel cartridge attachable to and detachable from the housing; and

a light emitting device, placed in the housing, for generating light to illuminate the fuel cartridge.

The fuel cell includes: an anode electrode to which fuel is supplied; a cathode electrode to which air is supplied; a membrane and electrode assembly sandwiched between the anode electrode and the cathode electrode; and an anode plate-shaped member stacked on the anode electrode.

The fuel cell device further includes a secondary cell to be charged by the fuel cell.

The fuel cell device further includes a terminal part, provided in the housing, for extracting power from the fuel cell. The terminal part is a USB port.

The invention is a fuel cell device including:

a cabinet to which a speaker unit is attached;

a supporting part for supporting the cabinet;

a base to which the supporting part is attached;

a fuel cell placed between the cabinet and the base and a fuel container for storing fuel for the fuel cell;

a circuit part contained in the base; and

a wireless receiver for generating input signal for the speaker unit.

A secondary cell is contained in the base.

### ADVANTAGE OF THE INVENTION

According to the invention, the light emitting device in the housing illuminates the fuel cartridge. This can facilitate checking of the amount of fuel remaining in the fuel cartridge.

### BRIEF DESCRIPTION OF THE DRAWINGS

FIG. 1 is a block diagram used to describe a USB charger to which the invention can be applied;

FIG. 2 is a connection diagram used to schematically describe the USB charger;

FIG. 3 is a front view, right side view, left side view, rear view, plan view and bottom view showing an appearance of a first embodiment of the invention;

FIG. 4 is an exploded perspective view used to describe an assembly process of the first embodiment of the invention;

FIG. 5 is an exploded perspective view used to describe the assembly process of the first embodiment of the invention;

FIG. 6 is an exploded perspective view used to describe the assembly process of the first embodiment of the invention;

FIG. 7 is an exploded perspective view used to describe the assembly process of the first embodiment of the invention;

FIG. 8 is a perspective view showing an appearance of a second example of the USB charger to which the invention is applied;

FIG. 9 is a front view, right side view, left side view, rear view, plan view and bottom view showing an appearance of a third example of the USB charger to which the invention is applied;

FIG. 10 is a front view, right side view and bottom view showing an appearance of a fourth example of the USB charger to which the invention is applied;

FIG. 11 is a front view, right side view, left side view and bottom view showing an appearance of a fifth example of the USB charger to which the invention is applied;

FIG. 12 is a front view, right side view, left side view and bottom view showing an appearance of a sixth example of the USB charger to which the invention is applied;

FIG. 13 is a front view, right side view and bottom view and a front view in which a different size of fuel cartridge is attached, showing an appearance of a seventh example of the USB charger to which the invention is applied;

FIG. 14 is a front view and bottom view and a front view in which a different size of fuel cartridge is attached, showing an appearance of a eighth example of the USB charger to which the invention is applied;

FIG. 15 is a front view, right side view and bottom view showing an appearance of a ninth example of the USB charger to which the invention is applied; and

FIG. 16 is a front view, right side view, left side view, rear view, plan view and bottom view showing an appearance of a wireless active speaker to which the invention is applied.

### MODE FOR CARRYING OUT THE INVENTION

Now, embodiments of the invention are described. The description is performed in the following order.

1. First Embodiment

2. Assembly Process

3. Second Embodiment

4. Variation Example

Note that, although the embodiments described below are specific preferable examples of the invention with various limitations for technical convenience, the scope of the invention is not intended to be limited to these embodiments unless otherwise stated to limit the invention in the following description.

### 1. First Embodiment

### Overview of USB Charger

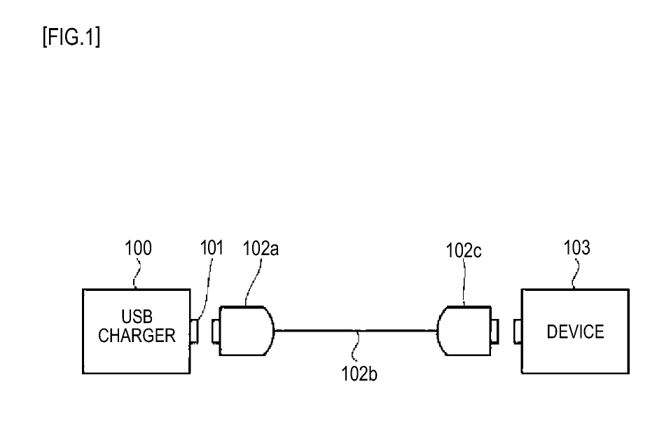

FIG. 1 shows an example of using a USB charger as an example of a fuel cell device. A USB charger 100 contains a fuel cell and a secondary cell, for example, a lithium ion secondary cell, as a charging power source. An electric double layer capacitor may be used in place of the lithium ion secondary cell. The fuel cell may use various materials, such as alcohol, sugar or lipid, for fuel. Here, as an example, what is called a direct methanol fuel cell (DMFC) using methanol as fuel is described.

The USB charger 100 includes a USB port 101. A USB device 103 is connected to the USB port 101 via a USB plug 102a, a USB cable 102b and a USB plug 102c. Note that the invention is applicable to any of USB 1.1, USB 2.0 and USB 3.0 standards.

A DC power supply generated by the charger 100 is provided to the USB device 103. The USB device 103 includes a secondary cell, for example, a lithium ion secondary cell, that is charged by the power of the charger 100. Note that, in an example described later, the USB charger 100 includes two USB ports.

The lithium ion secondary cell in the USB device 103 is charged using a CC-CV (constant-current constant-voltage) charging method that is a combination of constant-current charging and constant-voltage charging. For example, when the cell voltage is equal to or less than a set voltage (e.g., 4.2 V), constant-current charging control is performed to perform constant-current charging by a constant current (e.g., 0.5 A per USB port). When the cell voltage (internal electromotive force) is increased by the charging and reaches 4.2 V, the operation is switched to constant-voltage charging control and charging current is gradually decreased. Then, when the charging current reaching a set charging-completion detection value is detected, charging completion is detected.

Such a charging control is performed by a charging control circuit in the USB device 103. The USB charger 100 outputs an output voltage of 5 V from the USB port 101, and the output current is gradually decreased from e.g., 0.5 A as charging progresses.

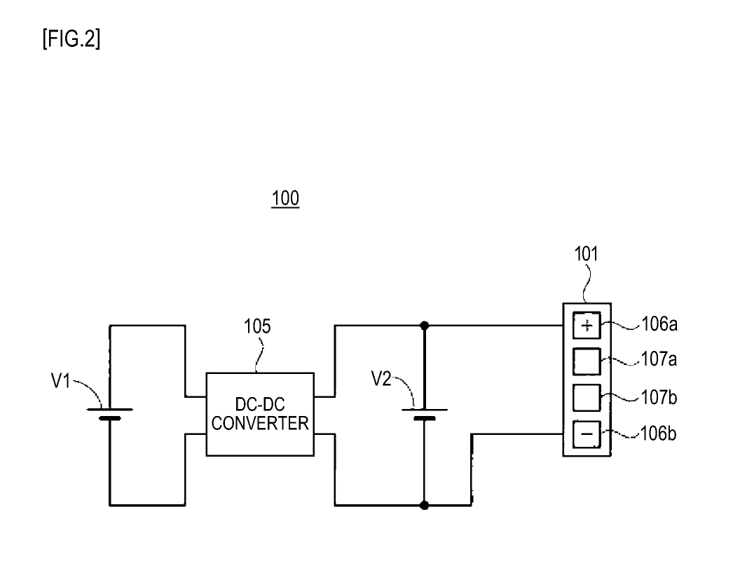

As shown in FIG. 2, a cell V1 corresponding to a fuel cell is connected to the input terminal of a DC-DC converter 105. The DC-DC converter 105 converts the voltage of the fuel cell to a constant voltage. A secondary cell V2, for example, a lithium ion secondary cell using a polymer electrolyte, is connected in parallel with the output terminal of the DC-DC converter 105. The voltage of the lithium ion secondary cell V2 is set to 5 V when fully charged. The output power of the DC-DC converter 105 is connected to power supply pins 106a and 106b of the USB port 101. Note that the DC-DC converter 105 may be provided at both outputs of the fuel cell V1 and secondary cell V2.

The USB port 101 includes data pins 107a and 107b in addition to the power supply pins. A microcomputer as a controller may be provided in the USB charger 100 to detect whether a device is connected or not, using the data pins 107a and 107b, and to perform communication with the device for authentication.

The DC-DC converter 105 converts the voltage input from the fuel cell V1 to around 5 V approximately equal to the voltage of the secondary cell V2. For example, the fuel cell of the USB charger 100 generates a constant power of 2.5 W. When a little or no load current flows as in the end stage of charging, current is supplied from the fuel cell V1 to a load, and charging current is supplied to the secondary cell V2 by excess power of the fuel cell V1. At the start of the power generation operation of the fuel cell or when load current is momentarily large, the secondary cell V2 outputs power to cover a deficit. Thus, a hybrid configuration of a fuel cell and a secondary cell can respond to a rapid increase in load current, thereby eliminating the need for a larger power supply unit.

Appearance of First Example of USB Charger

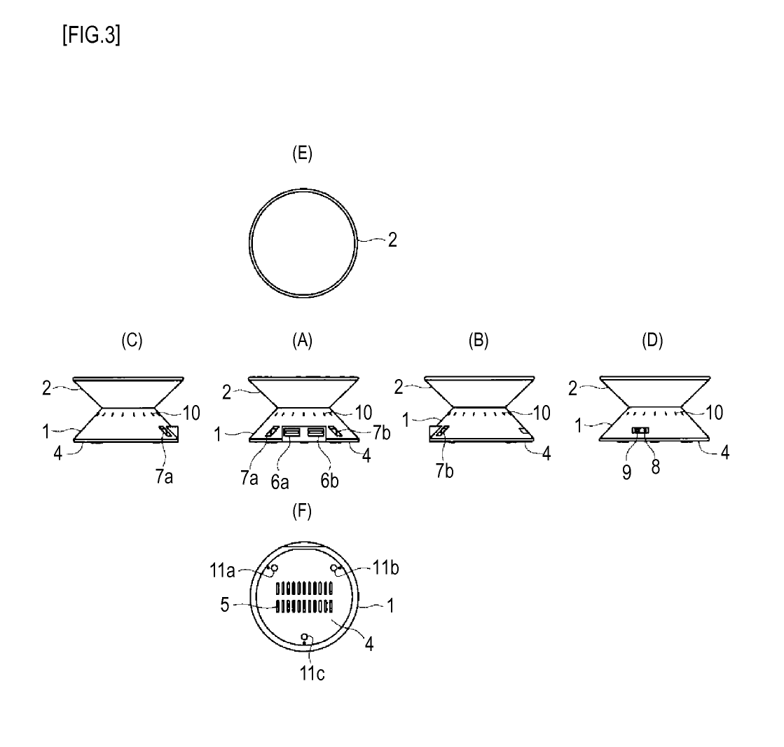

As shown in FIG. 3, the first embodiment of the invention has a configuration in which a truncated cone-shaped fuel cartridge 2 with the head down is attached to the head of a truncated cone-shaped housing 1. The fuel cartridge 2 is configured to be a fuel cartridge attachable to and detachable from the housing 1 or is configured to be a container fixedly attached to the housing 1 and capable of being refueled from the outside. The fuel cartridge 2 is a transparent or translucent container made of a glass or translucent synthetic resin material. The fuel cartridge 2 can store fuel, for example, methanol-water solution. Here, FIG. 3A is a front view; FIG. 3B is a right side view; FIG. 3C is a left side view; FIG. 3D is a rear view; FIG. 3E is a plan view; and FIG. 3F is a bottom view.

The housing 1 is made of a metal and contains a fuel cell, a lithium ion secondary cell, a wiring board on which a control circuit and the like are mounted, a light-emitting diode and the like as described later. The bottom surface of the housing 1 is covered with a bottom plate 4. A plurality of air-intake holes 5 are formed in the bottom plate 4 to supply air to the fuel cell. Furthermore, legs 11a, 11b and 11c made of a synthetic resin are provided in order to form a space for air intake under the bottom plate 4.

Two USB ports 6a and 6b are provided in the periphery of the housing 1. Manual switches 7a and 7b are provided near the USB ports 6a and 6b, respectively. Furthermore, a light-emitting diode (LED) 8 and a communication connector 9 are provided on the rear surface of the housing 1. The LED 8 is lit in, for example, green when the fuel cell is in operation, and is lit in, for example, orange when the fuel cell is outputting power. The manual switches 7a and 7b are push button switches for switching whether or not to output power from the USB ports 6a and 6b, respectively. For example, pushing the manual switch 7a causes the power source to output power from the USB port 6a and the LED 8 to be lit in orange. The communication connector 9 is for test purpose.

A plurality of air-discharge holes 10 are formed in the upper portion of the periphery of the housing 1. In FIG. 3, the air-discharge holes 10 are formed near the top surface of the housing 1. In the housing 1, the air-discharge holes 10 are formed above the level of the fuel cell. Gas in the housing 1 is discharged to the outside through the air-discharge holes 10. Furthermore, light from an LED provided in the housing 1 works as an illumination for the fuel cartridge 2, which can facilitate checking of the fluid level of the fuel cartridge 2, thus, checking of the amount of remaining fuel.

### 2. Assembly Process

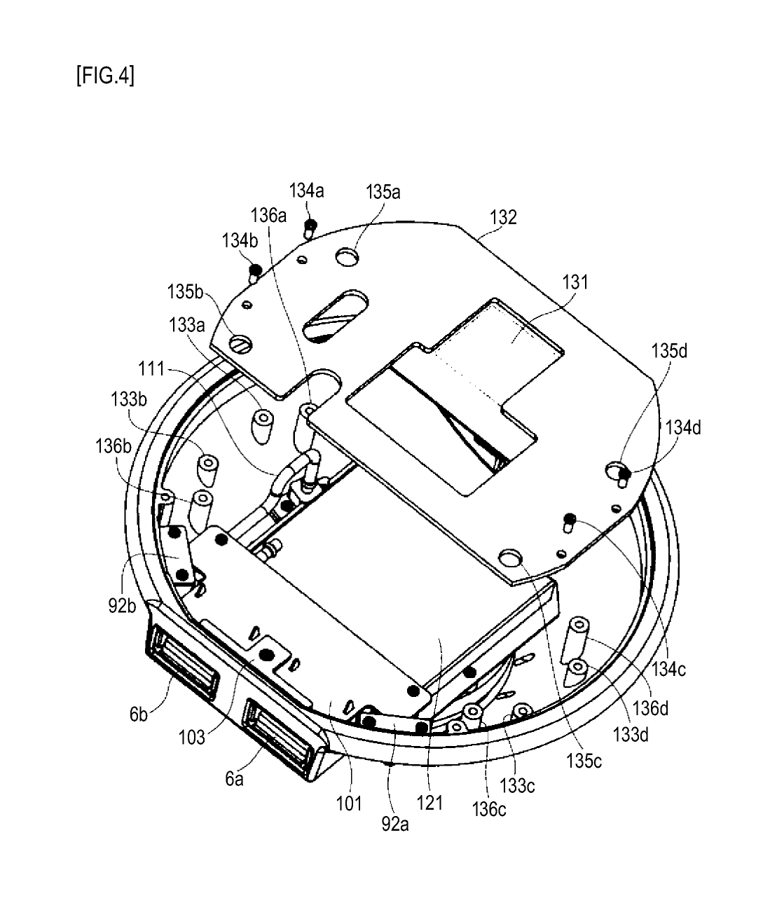

Now, the structure of the housing 1 and the components contained in the housing 1 are described in more detail with reference to FIGS. 4 to 7. FIGS. 4 to 7 are shown in the order according to the assembly sequence.

As shown in FIG. 4, in the housing 1, a plurality of fixed axles extending from top to bottom (the figure is drawn with the head down) are provided integrated with the housing 1. Screw holes are formed at the tips of the fixed axles. The components are mounted by screwing screws into the screw holes. The housing 1 and the plurality of fixed axles are made of a metallic material, for example, aluminum.

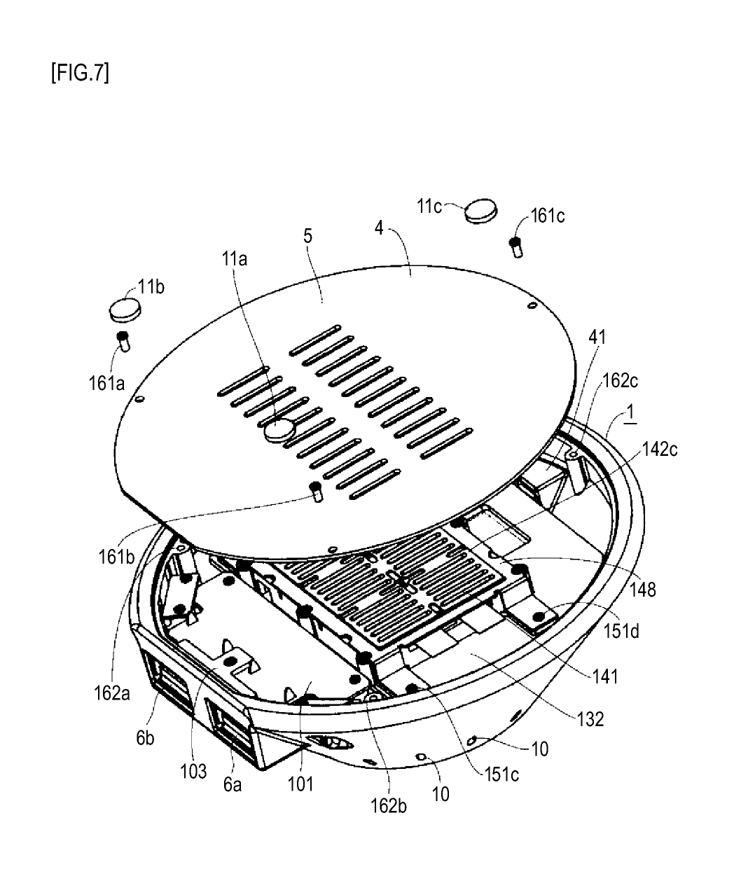

As shown in FIG. 7, a unit 41 to which the LED 8 for operation mode indication, the LED for illumination and the communication connector 9, which are described above, are to be attached is attached to the housing 1. The LED for operation mode indication may double as the LED for illumination. The unit 41 includes an optical element, such as a lens, for guiding light from the LED to the upper fuel cartridge 2. The LED in the unit 41 illuminates the fuel cartridge 2 attached to the upper opening, which can facilitate checking of the amount of fuel remaining in the fuel cartridge 2.

An attachment mechanism for attaching/detaching the fuel cartridge 2 is provided in the upper portion of the housing 1. On the underside of the attachment mechanism, an LED/switch board on which components related to the LEDs and switches are mounted is placed. A needle for drawing fuel from the fuel cartridge protrudes in the attachment mechanism. In order to supply fuel to the fuel cell, a fuel pump is used.

As shown in FIG. 4, button switch units (corresponding to the manual switches 7a and 7b in FIG. 3) are attached to the housing 1 with button holders 92a and 92b. The USB terminal unit 101 including a wiring board is attached to the housing 1. The USB terminal unit 101 includes the two USB ports 6a and 6b and a USB spacer 103. The USB port terminal unit 101 is attached to the housing 1 by screwing screws into the screw holes of some of the fixed axles of the housing 1.

As shown in FIG. 4, one end of a flexible fuel supply tube 111 is inserted into the end of the needle. As described later, the other end of the tube 111 is connected to the fuel cell, then fuel is supplied to the fuel cell through the tube 111.

A lithium ion secondary cell 121 is attached to the LED/switch board with, for example, a double-stick tape. As shown in FIG. 4, a chassis 132 on which a main board 131 is secured is attached to the housing 1. On the main board 131, circuit components, such as a fuel cell control circuit, a controlling central processing unit (CPU) and a memory, are mounted. The chassis 132 is attached to the housing 1 by screwing screws 134a, 134b, 134c and 134d into the screw holes of the fixed axles 133a, 133b, 133c and 133d of the board housing 1. Furthermore, holes 135a, 135b, 135c and 135d are formed in the chassis 132. The holes 135a-135d are formed at positions corresponding to those of fixed axles 136a, 136b, 136c and 136d.

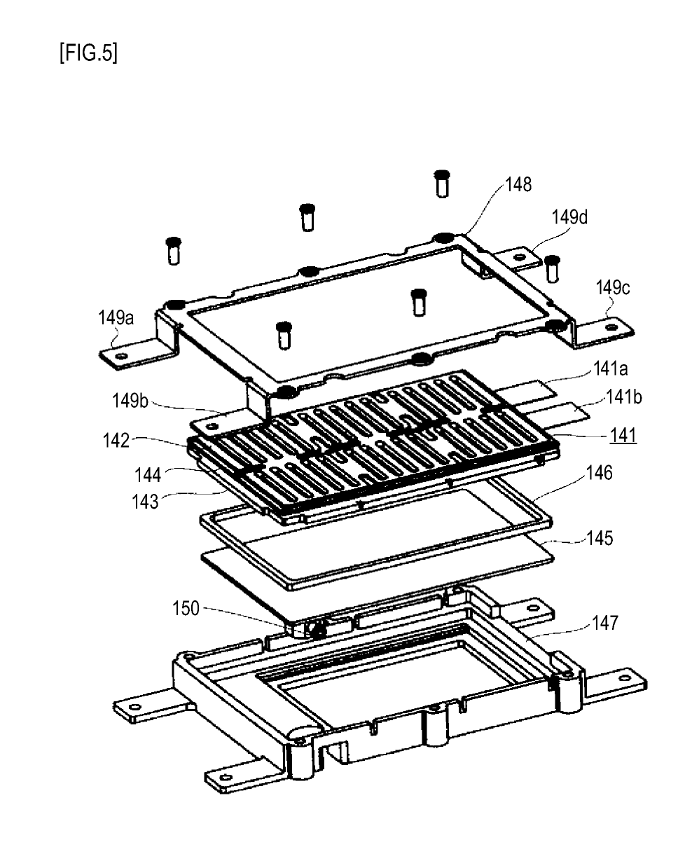

The fuel cell attached to the chassis 132 has a structure shown in FIG. 5. The fuel cell includes a power generation part 141. For example, in the power generation part 141, six power generation units are arranged in a plane, connected in series. In each of the power generation units, membrane and electrode assemblies are connected by insulating sheet or the like, each membrane and electrode assembly having a structure in which an electrolyte membrane is sandwiched between an anode electrode and an cathode electrode. Furthermore, a membrane and electrode assembly 144 is sandwiched between a cathode plate (cathode plate-shaped member) 142 and an anode plate (anode plate-shaped member) 143, which include a collector and a insulating layer. Leads 141a and 141b corresponding to positive and negative electrodes are extracted from the power generation part 141.

Furthermore, a fuel pump 145 for supplying fuel to the anode electrode is provided with a packing 146 in between. The fuel pump 145, which is, for example, a micropump using a piezoelectric device, supplies fuel to the power generation part 141. For the collector of the cathode plate 142, a perforated metal or mesh made of stainless steel, aluminum or the like is used.

The power generation part 141, packing 146 and fuel pump 145 are stacked and contained in a frame 147. Furthermore, a frame 148 and screws secure the stack. The frame 148 includes attachment tabs 149a, 149b, 149c and 149d at the corners. The frame 147 also includes attachment tabs at positions similar to those of the frame 148. In these tabs, holes through which screws are screwed are formed. Furthermore, a fuel receiver 150 is formed on the fuel pump 145.

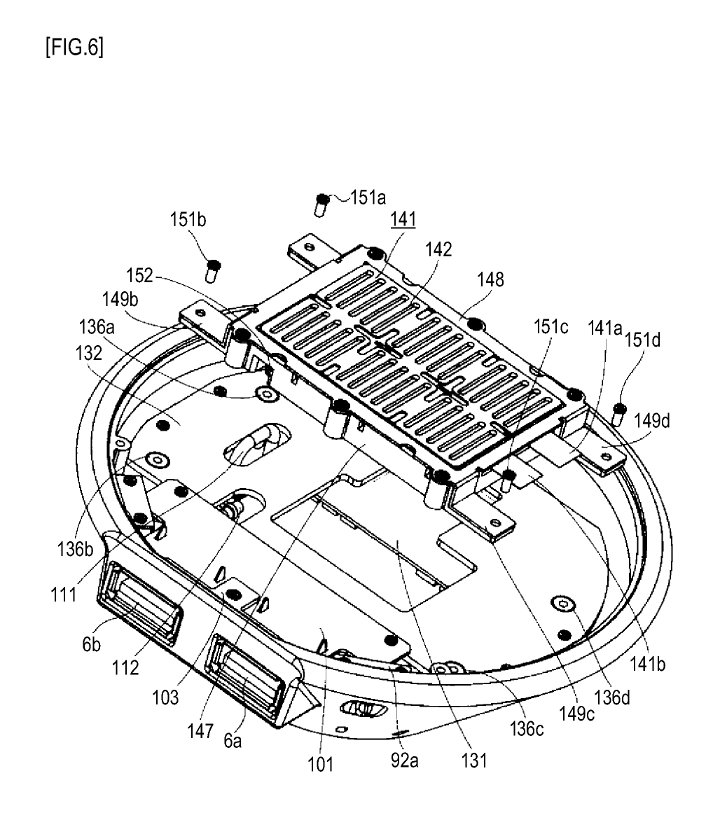

As shown in FIG. 6, the tips of the fixed axles 136a-136d are positioned in the holes 135a-135d of the chassis 132. The holes formed in the tabs 149a-149d of the frames 147 and 148 are aligned over the screw holes formed in the fixed axles 136a-136d. Then, the screws 151a, 151b, 151c and 151d are screwed into the fixed axles 136a-136d through the tabs 149a-149d to attach the fuel cell (power generation part 141) to the housing 1.

Thus, when the fuel cell has been attached, the end 112 of the fuel supply tube 111 is connected to the fuel receiver 150 of the fuel pump 145. Furthermore, a wiring harness is connected.

As shown in FIG. 7, the bottom plate 4 is attached to the housing 1. The bottom plate 4 includes the air-intake holes 5. The bottom plate 4 is attached to the housing 1 by screwing screws 161a, 161b and 161c into screw holes 162a, 162b and 162c of the frame 1. Furthermore, the legs 11a, 11b and 11c made of a synthetic resin are attached to the bottom plate 4. The legs 11a-11c provides a space under the bottom plate 4 to smooth the air intake.

Heat Transfer

In the first embodiment of the invention described above, the power generation part 141 is heated up to about 45 C-50 C during power generation operation. The power generation part 141 is secured to the fixed axles 136a-136d with the frames in between. The fixed axles 136a-136d are formed integrated with the housing 1. Thus, the heat of the power generation part 141 is transferred to the housing 1 through the fixed axles 136a-136d. The fixed axles 136a-136d are made of a material having a good heat transferability, such as aluminum.

The heat transferred to the housing 1 heats the air in the space within the housing 1 to cause upward air flow. The heated air is discharged to the outside through the air-discharge holes 10 formed in the upper portion of the housing 1. The upward air flow increases the amount of air taken in through the air-intake holes 5 formed in the bottom plate 4 of the housing 1. The amount of air (oxygen) taken into the power generation part 141 also increases. This can increase the output of the power generation part 141. Furthermore, advantageously, this invention does not use an air intake fan, which does not increase power consumption. Furthermore, discharging the air in the housing 1 to the outside, which can provide heat dissipation effect.

Appearance of Second Example of USB Charger

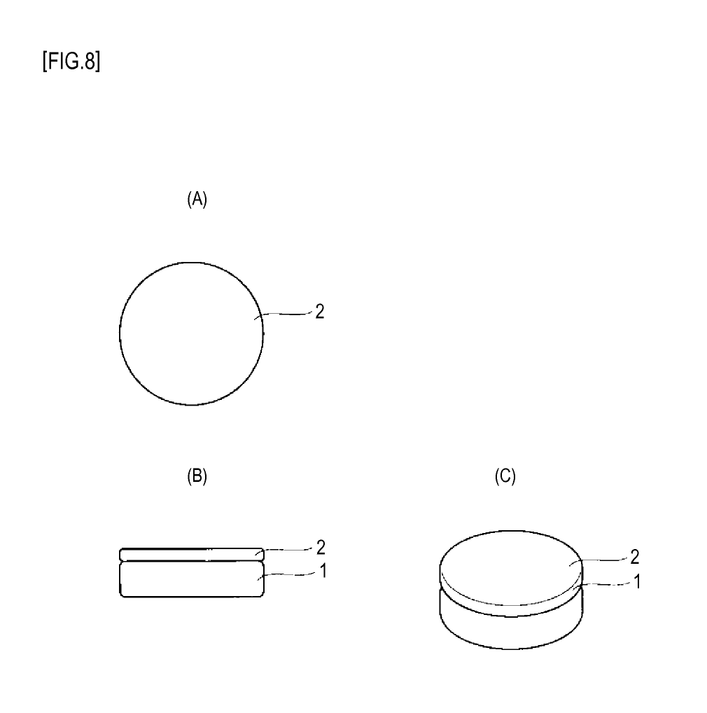

A second example of the USB charger to which the invention is applied is shown in FIG. 8. A housing 1 has a cylindrical configuration with a disc-shaped fuel cartridge 2 attached thereto. The fuel cartridge 2 is a transparent or translucent container made of a glass or translucent synthetic resin material. The fuel cartridge 2 can store fuel, for example, methanol-water solution. Here, FIG. 8A is a plan view; FIG. 8B is a front view; and FIG. 8C is a perspective view.

Similarly to the above-described first example (see FIG. 3), the housing 1 contains a fuel cell, a lithium ion secondary cell, a wiring board on which a control circuit and the like are mounted, a light-emitting diode, a USB port, a switch and the like. The bottom surface of the housing 1 is covered with a bottom plate. Similarly to the first example, but not shown, a plurality of air-intake holes are formed in the bottom plate to supply air to the fuel cell, and three legs are attached to the underside of the bottom plate. Furthermore, similarly to the first example, but not shown, two USB ports are provided in the periphery of the housing 1, and manual switches are provided near the respective USB ports. Furthermore, an LED and a communication connector are provided on the rear surface of the housing 1. A plurality of air-discharge holes may be formed in the upper portion of the periphery of the housing 1. Light from an LED provided in the housing 1 works as an illumination for the fuel cartridge 2, which can facilitate checking of the fluid level of the fuel cartridge 2, thus, checking the amount of remaining fuel.

Appearance of Third Example of USB Charger

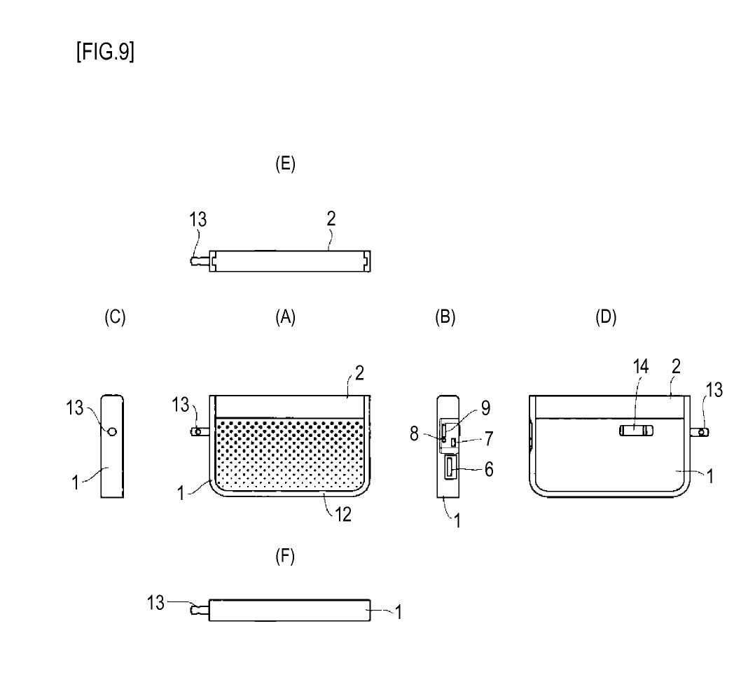

A third example of the USB charger to which the invention is applied is shown in FIG. 9. FIG. 9A is a front view; FIG. 9B is a right side view; FIG. 9C is a left side view; FIG. 9D is a rear view; FIG. 9E is a plan view; and FIG. 9F is a bottom view. Having a thin plate shape as a whole, a housing 1 has a square tube-shaped fuel cartridge 2 attached to the upper portion of the housing 1. A plurality of air-intake holes 12 are formed in the front surface of the housing 1.

The third example has a portable configuration, whereas the first and second examples have a fixed (stationary) configuration. A power generation part, secondary cell, board and the like are stacked in the housing 1 in the thickness direction of the housing 1. The power generation part is attached in parallel with the front face of the housing 1, and air is supplied to a cathode plate through the air-intake holes 12. An attachment mechanism 13 for attaching a hand carry strap is provided on one side surface of the housing 1. A cartridge lock operation key 14 for locking/unlocking the attachment of the fuel cartridge 2 is provided on the rear surface of the housing 1.

A USB port 6, manual switch 7, LED 8 and communication connector 9 are provided in one side surface of the housing 1. The LED 8 is lit in, for example, green when the fuel cell is in operation, and is lit in, for example, orange when the fuel cell is outputting power. The manual switches 7 is a push button switch for switching whether or not to output power from the USB port 6. The communication connector is for test purpose. Light from an LED provided in the housing 1 works as an illumination for the fuel cartridge 2, which can facilitate checking of the fluid level of the fuel cartridge 2, thus, checking the amount of remaining fuel.

Appearance of Fourth Example of USB Charger

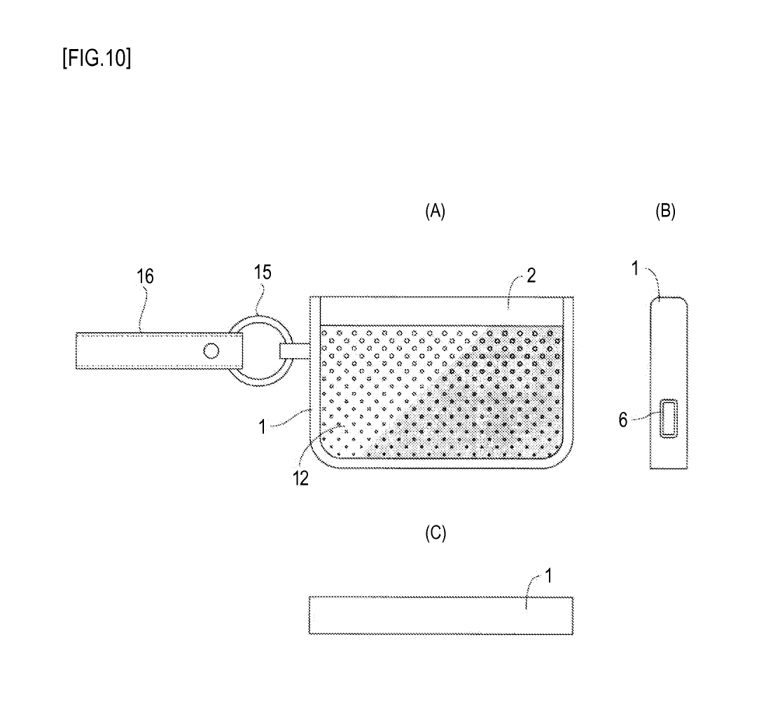

A fourth example of the USB charger to which the invention is applied and which is portable is shown in FIG. 10. FIG. 10A is a front view; FIG. 10B is a right side view; and FIG. 10C is a bottom view. Having a thin plate shape as a whole, a housing 1 has a square tube-shaped fuel cartridge 2 attached to the upper portion of the housing 1. A power generation part, secondary cell, board and the like are stacked in the housing 1 in the thickness direction of the housing 1. A plurality of air-intake holes 12 are formed in the front surface of the housing 1. A strap 15 is attached to one side surface with a ring-shaped attachment 14 in between. A USB port 6 is provided in the other side surface of the housing 1. The power generation part is attached in parallel with the front face of the housing 1, and air is supplied to a cathode plate through the air-intake holes 12. An LED provided in the housing 1 illuminates the fuel cartridge 2.

In the fourth example, similarly to the third example (see FIG. 9), a manual switch, LED and communication connector may be provided near the USB port 6.

Appearance of Fifth Example of USB Charger

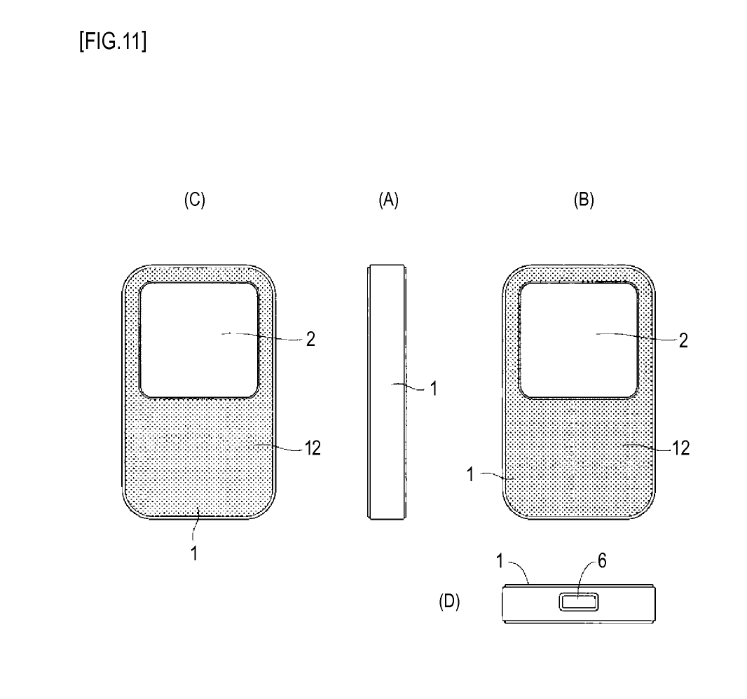

A fifth example of the USB charger to which the invention is applied and which is portable is shown in FIG. 11. FIG. 11A is a front view; FIG. 11B is a right side view; and FIG. 11C is a bottom view. Having a thin plate shape as a whole, a housing 1 has a fuel cartridge 2 attached to the upper portion of the housing 1. A power generation part, secondary cell, board and the like are stacked in the housing 1 in the thickness direction of the housing 1. An LED in the housing 1 illuminates the fuel cartridge 2. A plurality of air-intake holes 12 are formed in the front surface of the housing 1. A USB port 6 is provided in the bottom surface of the housing 1. The power generation part is attached in parallel with the side of the housing 1, and air is supplied to a cathode plate through the air-intake holes 12.

In the fifth example, similarly to the third example (see FIG. 9), a manual switch, LED and communication connector may be provided near the USB port 6.

Appearance of Sixth Example of USB Charger

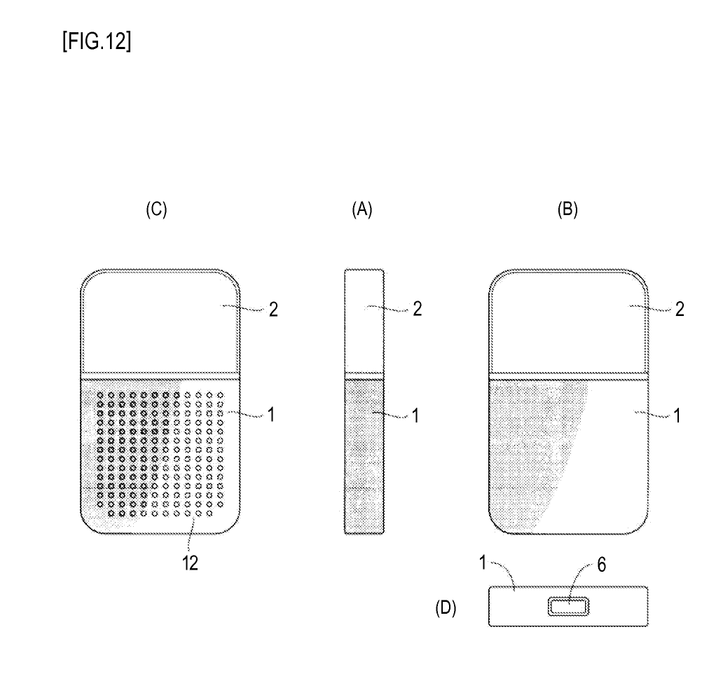

A sixth example of the USB charger to which the invention is applied and which is portable is shown in FIG. 12. FIG. 12A is a front view; FIG. 12B is a right side view; FIG. 12C is a left side view; and FIG. 12D is a bottom view. Having a thin plate shape as a whole, a housing 1 has a fuel cartridge 2 attached to the upper portion of the housing 1. A power generation part, secondary cell, board and the like are stacked in the housing 1 in the thickness direction of the housing 1. An LED in the housing 1 illuminates the fuel cartridge 2. A plurality of air-intake holes 12 are formed in one side surface of the housing 1. A USB port 6 is provided in the other bottom surface of the housing 1. The power generation part is attached in parallel with the side of the housing 1, and air is supplied to a cathode plate through the air-intake holes 12.

In the sixth example, similarly to the third example (see FIG. 9), a manual switch, LED and communication connector may be provided near the USB port 6.

Appearance of Seventh Example of USB Charger

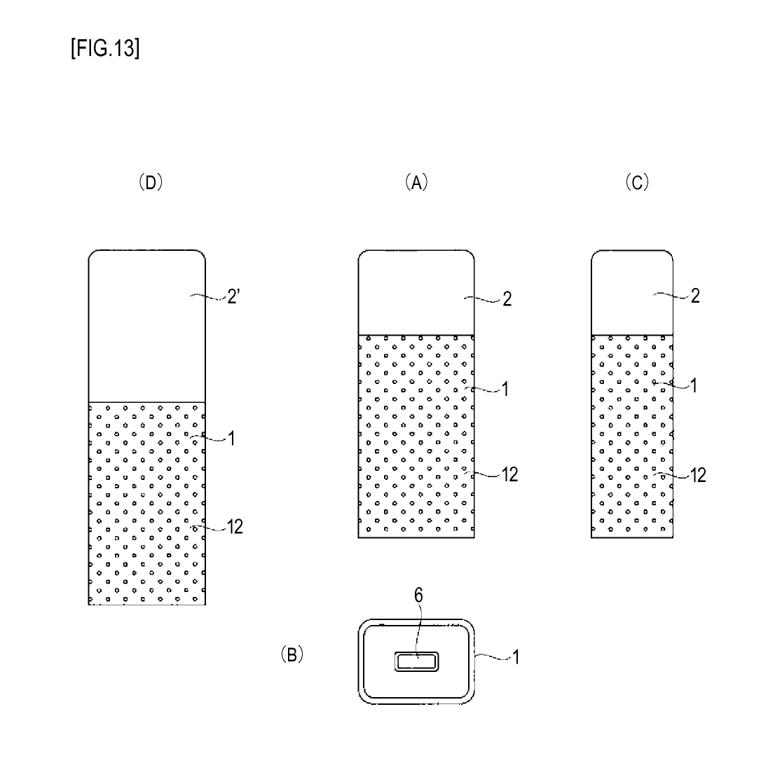

A seventh example of the USB charger to which the invention is applied and which is portable is shown in FIG. 13. FIG. 13A is a front view; FIG. 13B is a bottom view; and FIG. 13C is a right side view. FIG. 13D is a front view of the USB charger in which a different size (capacity) of fuel cartridge 2′ is attached to a housing 1. Having a square tube shape as a whole, the housing 1 has the fuel cartridge 2 or 2′ attached to the upper portion of the housing 1. A power generation part, secondary cell, board and the like are stacked in the housing 1. An LED in the housing 1 illuminates the fuel cartridge 2 or 2′. A plurality of air-intake holes 12 are formed all over the periphery of the housing 1. A USB port 6 is provided in the other bottom surface of the housing 1. The power generation part is attached in parallel with the side of the housing 1, and air is supplied to a cathode plate through the air-intake holes 12.

In the seventh example, similarly to the third example (see FIG. 9), a manual switch, LED and communication connector may be provided near the USB port 6.

Appearance of Eighth Example of USB Charger

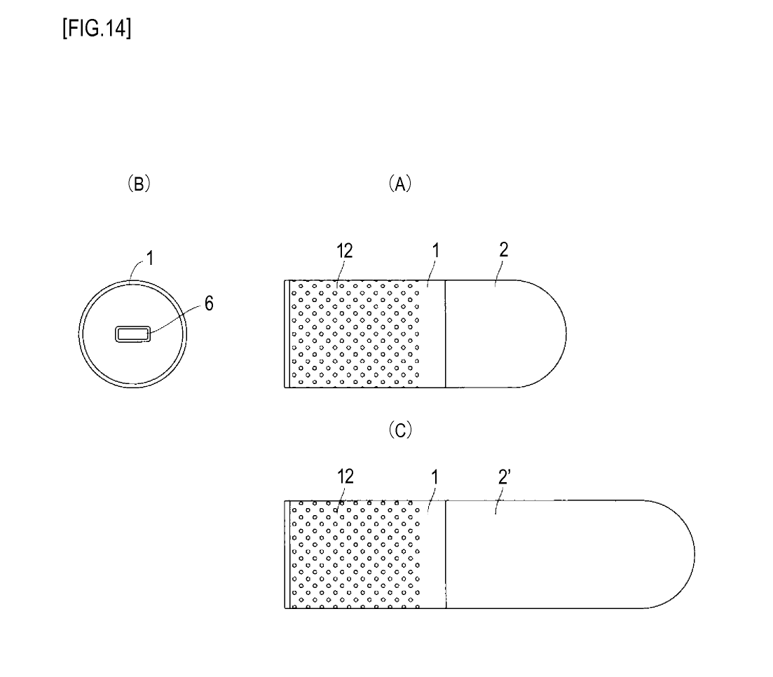

A eighth example of the USB charger to which the invention is applied and which is portable is shown in FIG. 14. FIG. 14A is a front view; and FIG. 14B is a bottom view. FIG. 14C is a front view of the USB charger in which a different size (capacity) of fuel cartridge 2′ is attached to a housing 1. Having a cylindrical shape as a whole, the housing 1 has the fuel cartridge 2 or 2′ attached to the upper portion of the housing 1. A power generation part, secondary cell, board and the like are stacked in the housing 1. An LED in the housing 1 illuminates the fuel cartridge 2 or 2′. A plurality of air-intake holes 12 are formed all over the periphery of the housing 1. A USB port 6 is provided in the other bottom surface of the housing 1. The power generation part is attached in parallel with the side of the housing 1, and air is supplied to a cathode plate through the air-intake holes 12.

In the eighth example, similarly to the third example (see FIG. 9), a manual switch, LED and communication connector may be provided near the USB port 6.

Appearance of Ninth Example of USB Charger

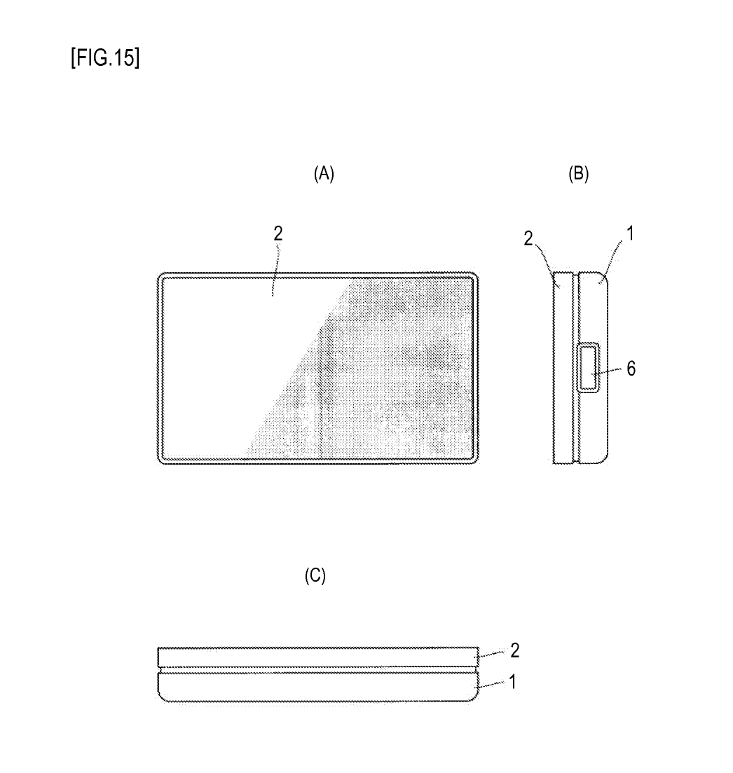

A ninth example of the USB charger to which the invention is applied is shown in FIG. 15. FIG. 15A is a front view; FIG. 15B is a right side view; and FIG. 15C is a bottom view. A fuel cartridge 2 is attached to a housing 1 such that the housing 1 and the fuel cartridge 2 having approximately the same size are stacked. A power generation part, secondary cell, board and the like are stacked in the housing 1 in the thickness direction of the housing 1. An LED in the housing 1 illuminates the fuel cartridge 2. A plurality of air-intake holes, not shown, are formed all over the surface of the housing 1 to which the fuel cartridge 2 is not attached. A USB port 6 is provided in the side surface of the housing 1. The power generation part is contained in parallel with the housing 1, and air is supplied to a cathode plate through the air-intake holes.

In the ninth example, similarly to the third example (see FIG. 9), a manual switch, LED and communication connector may be provided near the USB port 6.

### 3. Second Embodiment

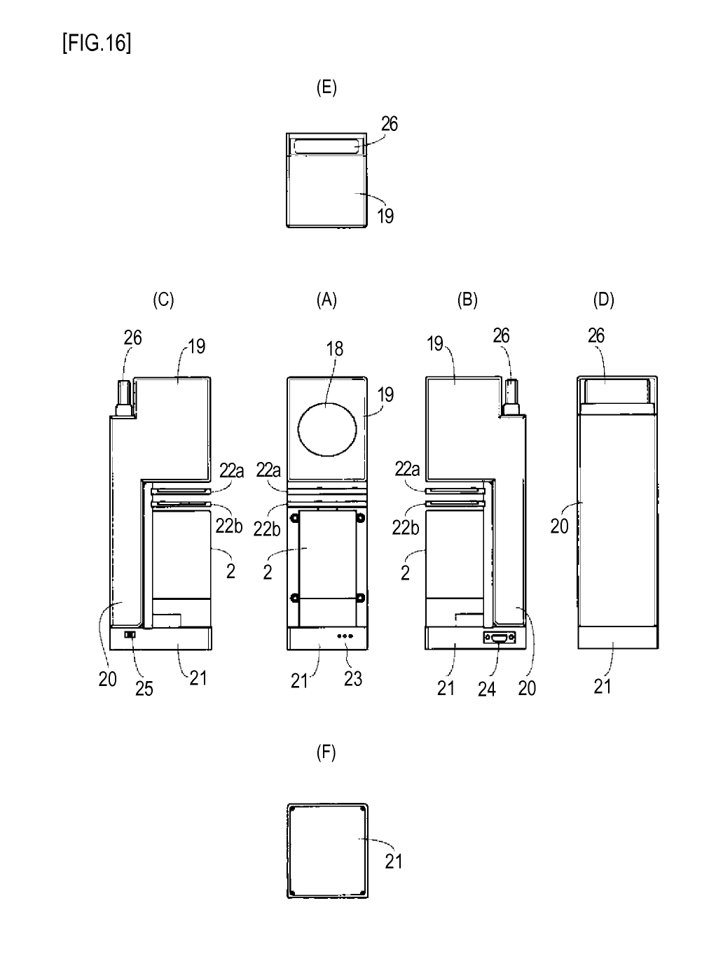

A second embodiment of the invention are described. FIG. 16 shows an appearance of the second embodiment. FIG. 16A is a front view; FIG. 16B is a right side view; FIG. 16C is a left side view; FIG. 16D is a rear view; FIG. 16E is a plan view; and FIG. 16F is a bottom view. In the second embodiment, the invention is applied to a wireless active speaker.

For example, a full-range speaker unit 18 is attached to a cabinet 19. The cabinet 19 is supported by a base 21 with a leg 20 in between. The thickness of the leg 20 is smaller than the depth of the cabinet 19. This forms a space to contain a fuel cartridge 2 in the lower portion of the cabinet 19. The fuel cartridge 2 is cylindrical-shaped. An LED illuminates the fuel cartridge 2 from the bottom, top or side surface of the fuel cartridge 2.

Furthermore, between the top surface of the fuel cartridge 2 and the bottom surface of the cabinet 19, two shelves 22a and 22b for containing a fuel cell protrude forward from the leg 20 at a right angle. Each shelf contains a power generation part of the fuel cell. For example, one shelf contains two power generation parts 141 (see FIG. 5), then four power generation parts 141 are contained in total. A main board on which a circuit for controlling the operation of the fuel cell is mounted is contained in one of the shelves 22a and 22b, the leg 20 or the base 21.

The base 21 contains a plurality of lithium ion secondary cells. Furthermore, a signal processing board on which a signal processor for generating drive signal for the speaker unit 18 is mounted is placed in the base 21. A plurality of LEDs 23 for indicating the operation state are placed on the front surface of the base 21. A communication connector 24 used for operation check or the like is provided in the right side surface of the base 21. A power-on switch 25 is provided on the left side surface of the base 21.

A step-like portion is formed on the rear side of the cabinet 19, on which a receiving antenna 26 is provided. The receiving antenna 26 receives audio playback signal from an audio signal playback apparatus not shown. The audio signal can be wirelessly transmitted using an existing method, such as FM transmission, millimeter-wave band transmission or the like. Signal received by the receiving antenna 26 is amplified by the signal processor in the base 21 and supplied to the speaker unit.

As described above, containing the lithium ion secondary cells and the signal processing board in the base 21 and placing the fuel cell at a higher level can lower the center of gravity and can prevent heat generated by the fuel cell from affecting the signal processing board. Furthermore, the fuel cartridge can be seen while music is playbacked by the speaker, facilitating checking of the amount of remaining fuel. The speaker according to the invention can be configured to be wireless to eliminate the need for a cable in any of power supplying and signal supplying.

### 4. Variation Example

The invention is not intended to be limited to the above-described embodiments, and various changes may be made based on the technical spirit of the invention.

### DESCRIPTION OF REFERENCE NUMERALS AND SIGNS

1 housing
2 fuel cartridge
4 bottom plate
5 air-intake holes
6a, 6b USB port
10 air-discharge holes
12 air-intake holes
91a, 91b button switch unit
101 USB terminal unit
111 fuel supply tube
121 lithium ion secondary cell
131 main board
132 chassis
136a, 136b, 136c, 136d fixed axle
141 power generation part
142 cathode plate
145 fuel pump
148 frame

1-7. (canceled)

8. A fuel cell device comprising:
a housing forming a fuel cell containing space for containing a fuel cell;
a fuel cartridge attachable to and detachable from the housing; and
a light emitting device placed in the housing, the light emitting device being configured to illuminate the fuel cartridge by generating light.

9. The fuel cell device of claim 8, wherein the fuel cell includes:
(a) an anode electrode to which fuel is supplied;
(b) a cathode electrode to which air is supplied;
(c) a membrane and electrode assembly sandwiched between the anode electrode and the cathode electrode; and
(d) an anode plate-shaped member stacked on the anode electrode.

10. The fuel cell device of claim 8, which includes a secondary cell to be charged by the fuel cell.

11. The fuel cell device of claim 8, which includes a terminal part provided in the housing, the terminal part being configured to extract power from the fuel cell.

12. The fuel cell device of claim 10, wherein the terminal part is a USB port

13. A fuel cell device comprising:
a cabinet to which a speaker unit is attached;
a supporting part for supporting the cabinet;
a base to which the supporting part is attached;
a fuel cell placed between the cabinet and the base and a fuel container for storing fuel for the fuel cell;
a circuit part contained in the base; and
a wireless receiver for generating input signal for the speaker unit.

14. The fuel cell device of claim 13, wherein a secondary cell is contained in the base.
